(19) United States
(12) Patent Application Publication
(10) Pub. No.: US 2019/0333434 A1
(43) Pub. Date: Oct. 31, 2019

(54) HIGH FILL RATE DISPLAY

(71) Applicant: MIKRO MESA TECHNOLOGY CO., LTD., Apia (WS)

(72) Inventor: Li-Yi CHEN, Tainan City (TW)

(21) Appl. No.: 15/965,970

(22) Filed: Apr. 29, 2018

(51) Int. Cl. G09G 3/20; G09G 3/32; G06F 3/01; G06T 19/00

(52) U.S. Cl. CPC G09G 3/2003; G09G 3/32; G09G 2300/0452; G06T 19/006; G06F 3/011

(57) ABSTRACT

A display is provided. The display includes a substrate and a at least three micro devices. The substrate has at least one pixel defined thereon. Said three devices are located within said pixel. Geometrical centers respectively of said three micro devices are arranged in a triangular shape. A ratio of a sum area of vertical projections of said three micro devices on the substrate to an area of a vertical projection of said pixel on the substrate is greater than or equal to 0.4.

### BACKGROUND

### Field of Invention

The present disclosure relates to a display with high fill rate of micro devices within a pixel.

### Description of Related Art

The statements in this section merely provide background information related to the present disclosure and do not necessarily constitute prior art.

In recent years, micro devices such as micro light emitting devices, or specifically, light emitting diodes (LEDs) have become popular in general and commercial lighting applications. As light sources, LEDs have many advantages including low energy consumption, long lifetime, small size, and fast switching, and hence conventional lighting, such as incandescent lighting, is gradually replaced by LED lights. These properties are promising for applications on displays.

One of the applications of micro light emitting devices is augmented reality (AR), mixed reality (MR), or virtual reality (VR).

### SUMMARY

According to some embodiments of the present disclosure, a display is provided. The display includes a substrate and three micro devices. The substrate has at least one pixel defined thereon. Said three micro devices are located within said pixel, and geometrical centers respectively of said three micro devices are arranged in a triangular shape. A ratio of a sum area of vertical projections of said three micro devices on the substrate to an area of a vertical projection of said pixel on the substrate is greater than or equal to 0.4.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a schematic top view of a portion of a display with a pixel defined thereon and three micro devices located within said pixel according to some embodiments of the present disclosure;

FIG. 1B is a schematic top view of a portion of a display with a pixel which includes three sub-pixels defined thereon and three micro devices located within said three sub-pixels respectively according to some embodiments of the present disclosure;

FIG. 2A is a schematic top view of a portion of a display with two pixels defined thereon and in an inverted arrangement with respect to each other according to some embodiments of the present disclosure;

FIG. 2B is a schematic top view of a portion of a display with two pixels defined thereon and in an inverted arrangement in which both of the pixels include three sub-pixels respectively according to some embodiments of the present disclosure;

FIG. 3A is a schematic top view of a portion of a display with a pixel defined thereon and four micro devices located within said pixel according to some embodiments of the present disclosure;

FIG. 3B is a schematic top view of a portion of a display with a pixel which includes four sub-pixels defined thereon and four micro devices located within said four sub-pixels respectively according to some embodiments of the present disclosure;

FIG. 4A is a schematic top view of a portion of a display with a pixel defined thereon and five micro devices located within said pixel according to some embodiments of the present disclosure;

FIG. 4B is a schematic top view of a portion of a display with a pixel which includes five sub-pixels defined thereon and five micro devices located within said five sub-pixels respectively according to some embodiments of the present disclosure;

FIG. 5 is a schematic top view of a portion of a display with a triangular pixel defined thereon and three micro devices located within said triangular pixel according to some embodiments of the present disclosure; and

FIG. 6 is a schematic top view of a portion of a display with a pixel defined thereon and three octagonal micro devices located within said pixel according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In various embodiments, description is made with reference to figures. However, certain embodiments may be practiced without one or more of these specific details, or in combination with other known methods and configurations. In the following description, numerous specific details are set forth, such as specific configurations, dimensions and processes, etc., in order to provide a thorough understanding of the present disclosure. In other instances, well-known semiconductor processes and manufacturing techniques have not been described in particular detail in order to not unnecessarily obscure the present disclosure. Reference throughout this specification to “one embodiment,” “an embodiment”, “some embodiments” or the like means that a particular feature, structure, configuration, or characteristic described in connection with the embodiment is included in at least one embodiment of the disclosure. Thus, the appearances of the phrase “in one embodiment,” “in an embodiment”, “in some embodiments” or the like in various places throughout this specification are not necessarily referring to the same embodiment of the disclosure. Furthermore, the particular features, structures, configurations, or characteristics may be combined in any suitable manner in one or more embodiments.

The terms “over,” “to,” “between” and “on” as used herein may refer to a relative position of one layer with respect to other layers. One element “over” or “on” another element or bonded “to” another element may be directly in contact with the other element or may have one or more intervening element. One element “between” elements may be directly in contact with the elements or may have one or more intervening elements.

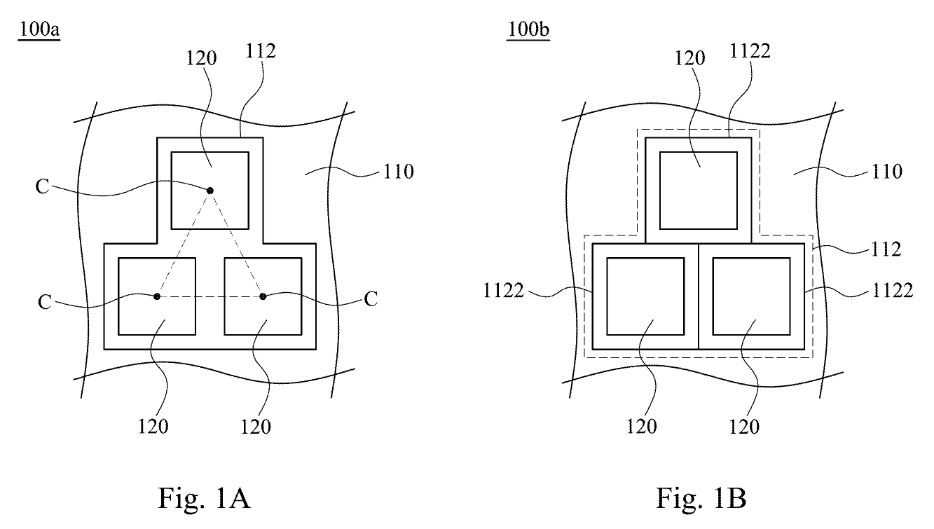

A display is provided in the present disclosure. Reference is made to FIG. 1A. FIG. 1A is a schematic top view of a portion of a display 100a with a pixel 112 defined thereon and three micro devices 120 located within said pixel 112 according to some embodiments of the present disclosure. The top view here refers to seeing along a direction from a dominant light exit surface to the display 100a. Said definition of the top view can be applied to the entire disclosure. In some embodiments, the display 100a includes a substrate 110 and at least three micro devices 120. The substrate 110 has at least one pixel 112 defined thereon. Said three micro devices 120 are located within said pixel 112, and geometrical centers C respectively of said three micro devices 120 are arranged in a triangular shape (as illustrated by dashed lines in FIG. 1A), such as in a delta arrangement. The geometrical center C referred to is a geometrical center C of a vertical projection of a micro device 120 on the substrate 110 viewed from said top view as shown in FIG. 1A. Said definition of the geometrical center C can be applied to the entire disclosure.

In some embodiments, a ratio of a sum area of vertical projections of said three micro devices 120 on the substrate 110 to an area of a vertical projection of said pixel 112 on the substrate 110 is greater than or equal to 0.4. In some embodiments, said ratio is greater than or equal to 0.6. In some embodiments, said ratio is substantially equal to 1. Said ratio can be defined as “fill rate”. As such, the display 100a disclosed in the above embodiments can have much higher fill rate within the pixel 112 comparing to a conventional LED display in which the fill rate is often lower than 0.25. As an exemplification in the present disclosure, if there are three micro devices that are square in shape located within one pixel, and a sum area of vertical projections of said three micro devices on a substrate is 8 μm*8 μm*3=192 μm², while an area of a vertical projection of said pixel on the substrate is 10 μm*10 μm*3=300 μm², then the fill rate is 192/300=0.64. In another example in which a pixel is square in shape and geometrical centers C respectively of three micro devices (with a sum area of vertical projections of said three micro devices on a substrate equals to 8 μm*8 μm*3=192 μm²) are arranged in a line shape, the size of said pixel to accommodate said three micro devices is 30 μm*30 μm=900 μm². As a result, the fill rate is 192/900=0.21.

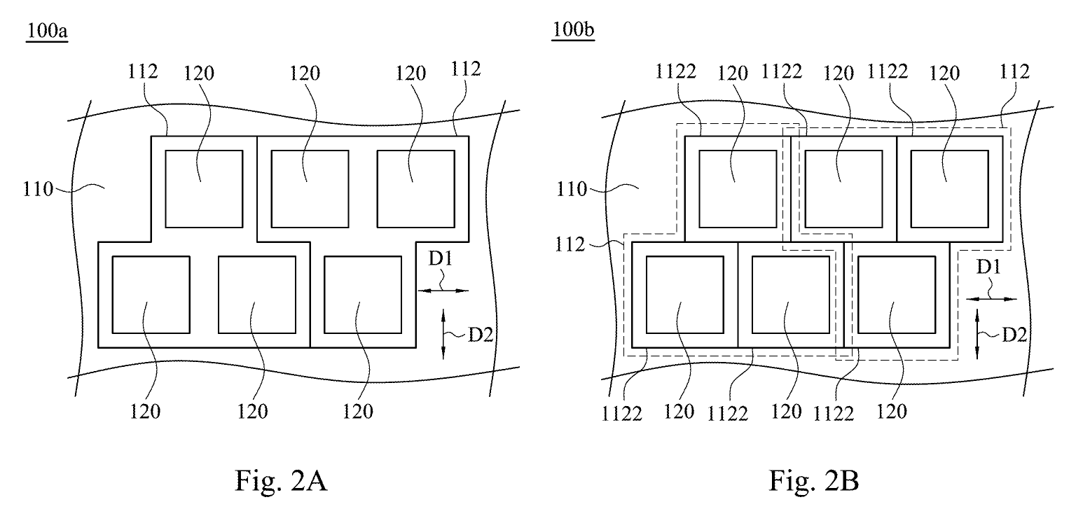

Reference is made to FIG. 1B. FIG. 1B is a schematic top view of a portion of a display 100b with a pixel 112 which includes three sub-pixels 1122 defined thereon and three micro devices 120 located within said three sub-pixels 1122 respectively according to some embodiments of the present disclosure. The dashed line of the pixel 112 is merely schematic for clear of understanding, and the dashed line of the pixel 112 is in fact completely overlapped with a periphery formed by the sub-pixels 1122 of the pixel 112. Said explanation on the dashed line of the pixel 112 can also be used in the pixels 112, 112a, and 112b as respectively illustrated in FIGS. 2B, 3B and 4B. As shown in FIG. 1B, in some embodiments, a plurality of sub-pixels 1122 (e.g., three sub-pixels 1122 as shown in FIG. 1B) are further defined within said pixel 112. Each of the sub-pixels 1122 may have at least one micro device 120.

In the above embodiments, a lateral length of one of said micro devices 120 is less than or equal to 40 μm. In some embodiments, a lateral length of each of said micro devices 120 is less than or equal to 40 μm. Said lateral length is defined as a maximum width of a micro device 120 viewed from the top views of FIGS. 1A to 6 of the present disclosure. In some embodiments, the lateral length of one of said micro devices 120 is less than or equal to 10 μm. In some embodiments, the lateral length of each of said micro devices 120 is less than or equal to 10 μm. In some embodiments, the lateral length of one of said micro devices 120 is less than or equal to 8 μm. In some embodiments, the lateral length of each of said micro devices 120 is less than or equal to 8 μm. In some embodiments, lateral lengths of the micro devices 120 within one pixel 112 are the same. In some embodiments, lateral lengths of the micro devices 120 within one pixel 112 are different from one another. In some embodiments, a lateral length of one of the micro devices 120 is different from a lateral length of a remaining part of the micro devices 120. Micro devices with lateral lengths within the ranges mentioned above have become increasingly important since modern applications such as augmented reality (AR), mixed reality (MR), and/or virtual reality (VR) have developed rapidly and become more and more popular. Since displays of said applications are close to human eyes in distance, it requires much higher pixel density (or pixel-per-inch, ppi) and/or higher ratio of effective light emitting area within one pixel to an area of said pixel comparing to conventional LED displays in order to match the human eyes capabilities for a realistic and immersive experience.

In some embodiments, one of the micro devices 120 is a red light emitting diode. In some other embodiments, one of the micro devices 120 is a green light emitting diode. In some other embodiments, one of the micro devices 120 is a blue light emitting diode. In some other embodiments, one of the micro devices 120 is a yellow light emitting diode. In some other embodiments, one of the micro devices 120 is a cyan light emitting diode. In some other embodiments, one of the micro devices 120 is an ultraviolet light emitting diode. Said different types of micro devices 120 are exemplifications and should not merely be limited thereto.

Reference is made to FIGS. 2A to 2B. FIG. 2A is a schematic top view of a portion of a display 100a with two pixels 112 defined thereon and in an inverted arrangement with respect to each other according to some embodiments of the present disclosure. FIG. 2B is a schematic top view of a portion of a display 100b with two pixels 112 defined thereon and in an inverted arrangement in which each of the pixels 112 includes three sub-pixels 1122 according to some embodiments of the present disclosure. As exemplified in FIGS. 2A and 2B, the displays 100a, 100b may include a plurality of said pixels 112. In some embodiments, two adjacent pixels 112 along one direction (e.g., first direction D1) are in an inverted arrangement. Said inverted arrangement is exemplified in, e.g. FIG. 2A, but should not be limited thereto.

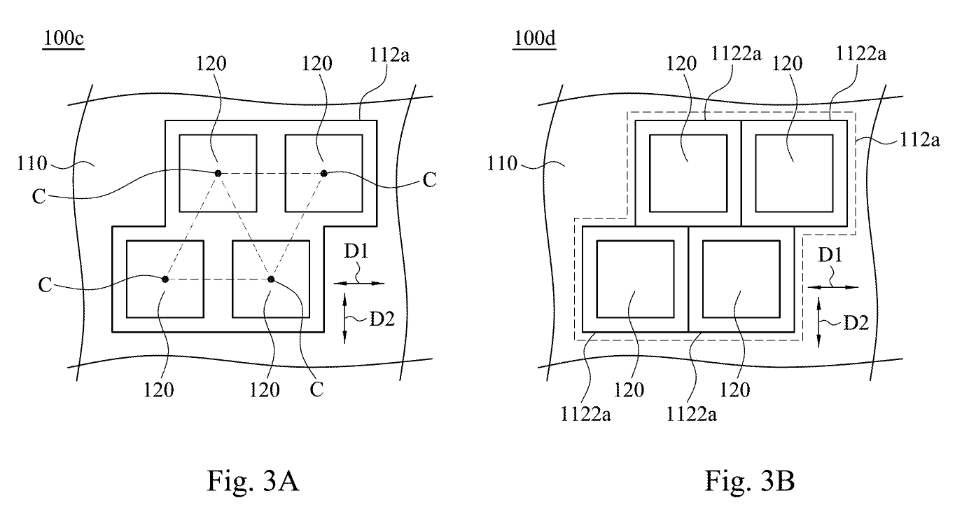

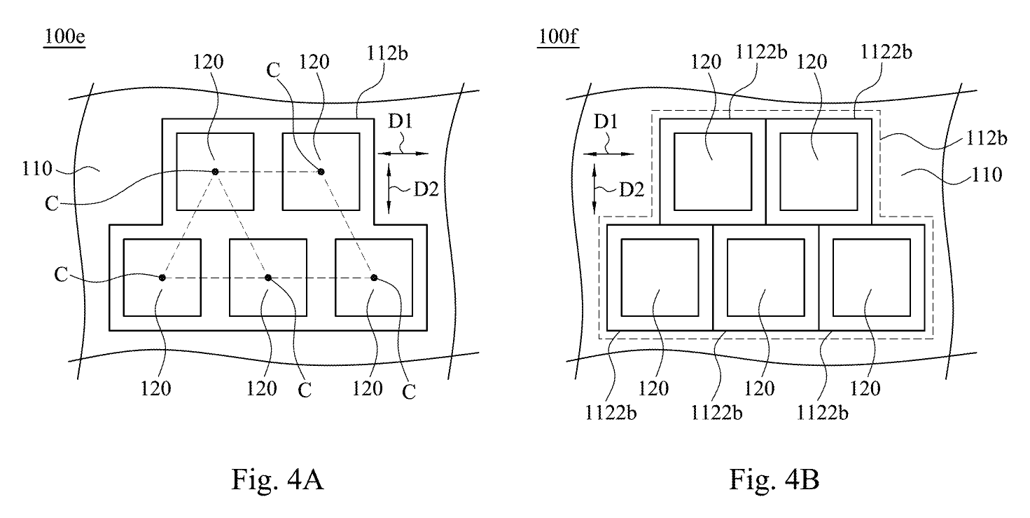

Reference is made to FIGS. 3A to 4B. FIG. 3A is a schematic top view of a portion of a display 100c with a pixel 112a defined thereon and four micro devices 120 located within said pixel 112a according to some embodiments of the present disclosure. FIG. 3B is a schematic top view of a portion of a display 100d with a pixel 112a which includes four sub-pixels 1122a defined thereon and four micro devices 120 located within said four sub-pixels 1122a respectively according to some embodiments of the present disclosure. FIG. 4A is a schematic top view of a display 100e with a pixel 112b defined thereon and five micro devices 120 located within said pixel 112b according to some embodiments of the present disclosure. FIG. 4B is a schematic top view of a portion of a display 100f with a pixel 112b which includes five sub-pixels 1122b defined thereon and five micro devices 120 located within said five sub-pixels 1122b respectively according to some embodiments of the present disclosure. As exemplified in FIGS. 3A to 4B, in some embodiments, more than three micro devices 120 are located within said pixels 112a, 112b, such as four micro devices 120 in which an embodiment is shown in FIGS. 3A and 3B, or five micro devices 120 in which an embodiment is shown in FIGS. 4A and 4B, but should not be limited thereto. In some embodiments with four micro devices located within one pixel, a geometrical center of the fourth micro device and two geometrical centers respectively of two of said three micro devices are arranged in a triangular shape. In some embodiments with four micro devices 120 located within said pixels 112a, geometrical centers C respectively of said four micro devices 120 are arranged in a parallelogrammic shape (as illustrated by dashed lines in FIG. 3A). In some embodiments with five micro devices located within one pixel, a geometrical center of the fifth micro device and two geometrical centers respectively of two of said four micro devices are arranged in a triangular shape. In some embodiments with five micro devices 120 located within said pixels 112b, geometrical centers C respectively of said five micro devices 120 are arranged in a trapezoidal shape (as illustrated by dashed lines in FIG. 4A).

In some embodiments, there are a plurality of micro devices located within one sub-pixel, and “a geometrical center of a micro device” herein becomes a common geometrical center of a sum of vertical projections of micro devices (located within one of the sub-pixels) on the substrate 110 viewed from said top view. Specifically, the fourth and fifth micro devices mentioned in the previous paragraph may be located within another two respective sub-pixels different from the original three sub-pixels, or the fourth and/or fifth micro devices may be located within one of said original three sub-pixels.

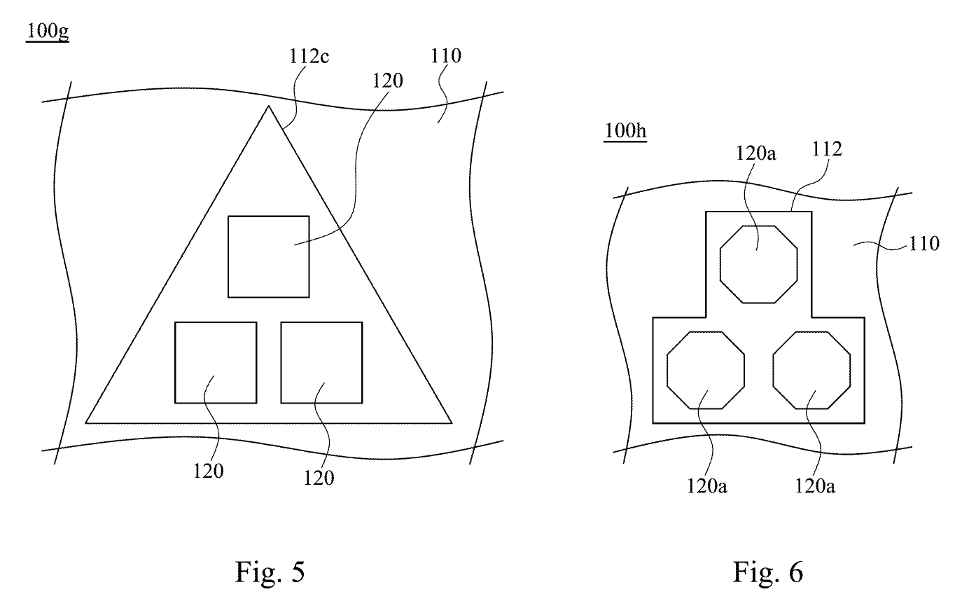

Reference is made to FIGS. 5 and 6. FIG. 5 is a schematic top view of a portion of a display 100g with a pixel 112c defined thereon which is triangular in shape and three micro devices 120 located within said triangular pixel 112c according to some embodiments of the present disclosure. FIG. 6 is a schematic top view of a portion of a display 100h with a pixel 112 defined thereon and three octagonal micro devices 120a located within said pixel 112 according to some embodiments of the present disclosure. Pixels may have different shapes. As exemplified in FIG. 5, in some embodiments, a shape of one of the pixels 112c is triangular, but should not be limited thereto. Besides, micro devices within one pixel may have the same shape or different shapes. In some embodiments, a shape of one of the micro devices within one pixel is different from shapes of a remaining part of the micro devices within said pixel. In some embodiments, shapes of micro devices within one pixel are the same. In some embodiments, a shape of one of the micro devices 120 is rectangular (as exemplified in 1A to 5). In some embodiments, a shape of one of the micro devices is circular. In some embodiments, a shape of one of the micro devices 120a is octagonal (as exemplified in FIG. 6). In some embodiments, a shape of one of the micro devices is hexagonal. Said shapes are shapes of a vertical projection of one of the micro devices on the substrate 110. Said shapes are exemplifications and should not merely be limited thereto.

In summary, a display with high pixel density is provided by a triangular shape arrangement of three of micro devices located within one pixel. Besides, the display also provides high ratio of effective light emitting area within one pixel to an area of said pixel by means of high fill rate of micro devices within one pixel. The display may have variety of potential applications such as augmented reality (AR), mixed reality (MR), and/or virtual reality (VR).

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A display, comprising:
a substrate having at least one pixel defined thereon; and
three micro devices located within said pixel, and geometrical centers respectively of said three micro devices being arranged in a triangular shape, wherein a ratio of a sum area of vertical projections of said three micro devices on the substrate to an area of a vertical projection of said pixel on the substrate is greater than or equal to 0.4.

2. The display of claim 1, wherein a lateral length of one of the micro devices is less than or equal to 40 μm.

3. The display of claim 1, wherein the lateral length of one of the micro devices is less than or equal to 10 μm.

4. The display of claim 1, wherein the lateral length of one of the micro devices is less than or equal to 8 μm.

5. The display of claim 1, wherein one of the micro devices is a red light emitting diode.

6. The display of claim 1, wherein one of the micro devices is a green light emitting diode.

7. The display of claim 1, wherein one of the micro devices is a blue light emitting diode.

8. The display of claim 1, wherein one of the micro devices is a yellow light emitting diode.

9. The display of claim 1, wherein one of the micro devices is a cyan light emitting diode.

10. The display of claim 1, wherein one of the micro devices is an ultraviolet light emitting diode.

11. The display of claim 1, wherein the display comprises a plurality of said pixels.

12. The display of claim 1, further comprising a fourth micro device located within said pixel.

13. The display of claim 12, wherein a geometrical center of the fourth micro device and two geometrical centers respectively of two of said three micro devices are arranged in a triangular shape.

14. The display of claim 12, further comprising a fifth micro device located within said pixel.

15. The display of claim 14, wherein a geometrical center of the fifth micro device and two geometrical centers respectively of two of said four micro devices are arranged in a triangular shape.

16. The display of claim 1, wherein a shape of one of the micro devices is different from shapes of a remaining part of the micro devices.

17. The display of claim 1, wherein shapes of said three micro devices are the same.

18. The display of claim 1, wherein lateral lengths of the micro devices are the same.

19. The display of claim 1, wherein a lateral length of one of the micro devices is different from lateral lengths of a remaining part of the micro devices.
